(19) United States
(12) Patent Application Publication
(10) Pub. No.: US 2012/0188502 A1
(43) Pub. Date: Jul. 26, 2012

(54) BIFOCAL OR MULTI-FOCAL CONTACT LENS

(75) Inventor: Jakob Abderhalden, Unterwasser (CH)

(73) Assignee: AHA Informatik AG, Unterwasser (CH)

(21) Appl. No.: 13/499,240

(22) PCT Filed: Sep. 28, 2010
(86) PCT No.: PCT/CH10/00232

§ 371 Date: Mar. 29, 2012

(30) Foreign Application Priority Data
Sep. 30, 2009 (CH) 1507/09
Jun. 9, 2010 (CH) 915/10

(51) Int. Cl. G02C 7/04

(52) U.S. Cl. 351/159.12; 351/159.73

(57) ABSTRACT

A bifocal or multi-focal contact lens (5) having a geometrical lens center point (4) comprises a near-circular near vision zone (10) having a first geometrical center point and a near-circular far vision zone (8) having a second geometrical center point. The near vision zone (10) and the far vision zone (8) are concentrically arranged, whereby the first geometrical center point and the second geometrical center point coincide and form a common correction center (6) and said correction center (6) is located at a distance from the lens center point (4). Said contact lens (5) ensures optimized visual acuity without intermediate zones, in particular in the case of presbyopia. Furthermore, said contact lens can be produced in a simple and low-cost manner.

### TECHNICAL FIELD

The present invention relates to a bifocal or multifocal contact lens as per the preamble of patent claim 1.

### PRIOR ART

Bifocal and multifocal contact lenses serve to correct different visual, defects. By way of example, they allow a nearsighted person, who at the same time suffers from age -dependent hyperopia, which is also referred to as presbyopia, to have visual-acuity correction over a large distance range.

Such bifocal and multifocal contact lenses usually have two or more concentric circular or annular zones with different optical corrections. This is illustrated in FIG. 20a. These zones are situated concentrically on the contact lens 5, with near-vision and distance-vision zones alternating. In the examples as per FIGS. 20c and 20s, a mid-vision zone 9 is present between the near-vision zone 10 and the distance-vision zone 8. A disadvantage of these contact lenses is that the desired visual acuity can no longer be reached, particularly in the case of elderly people as a result of the age-related smaller pupil diameter. This disadvantage is even more amplified if three different focal lengths, and hence three different correction zones, are required, and, in the case of a reduced pupil diameter, it is no longer possible to position sufficiently large correction zones of the respectively required focal length over the pupil in order to enable good vision.

In other embodiments, two correction zones with a correction for distance vision and near vision are applied onto the contact lens, with these zones being separated by a horizontal intermediate zone Z running through the center of the lens. This is illustrated in FIG. 20b. A disadvantage of these contact lenses is that the intermediate zone Z causes problems, particularly in the case of large positive corrections in the near-vision zone 10 with respect to the distance-vision zone 8. This intermediate zone Z is difficult to produce and has a disturbing effect on the optical corrections and hence on achieving the desired visual acuity.

WO 2008/002976 moreover discloses a contact lens with at least one near-vision zone and at least one distance-vision zone. The near-vision and distance-vision zones respectively have a circular or elliptical design, and lie within one another. In doing so, they contact one another tangentially at their edges.

EP 0 624 811 shows a multifocal contact lens with a segment-like near-vision-zone region and a circular distance-vision-zone region, which touches an edge of the near-vision-zone region.

EP 0 949 529 describes a toric multifocal contact lens for correcting different corneal curvatures in various optical zones. By way of example, the lens has a circular near-vision-zone region, which is arranged concentrically in a circular distance-vision-zone region.

### DESCRIPTION OF THE INVENTION

It is an object of the invention to create a bifocal or multifocal contact lens, which ensures optimized visual acuity for nearby and at a distance, even in the case of strong corrections, more particularly in the combination of severe myopia with age-related presbyopia.

This object is achieved by a contact lens with the features of claim 1.

The bifocal or multifocal contact lens according to the invention with a geometric lens center point has a circle-like near-vision zone with a first geometric center point and a circle-like distance-vision zone with a second geometric center point. The near-vision zone and the distance-vision zone are arranged concentrically, as a result of which the first geometric center point and the second geometric center point coincide and form a common correction center. In doing so, this correction center is situated at a distance from the lens center point,

Thanks to the eccentrically applied circle-shaped and ring-shaped correction, there are no distracting intermediate zones, which can, for example, create reflections that irritate the user. The correction zones preferably merge continuously and abruptly into one another. In place of circle-shaped correction zones, it is also possible to use elliptical, oval or similar shapes. Since the individual correction zones are superposed on one another, the outer correction zones have a ring-like shape. Moreover, it is not necessary for the whole ring or the whole circle to be situated on the lens. Depending on the distance of the correction center from the center point of the contact lens, the circles or rings may only be present in sections.

Thanks to the upward displacement of the center of the correction zones relative to the center of the lens, a downward displacement of the lens, caused by eye movement, brings about an effective distance-vision zone, which is enlarged for distance vision. An upward displacement of the lens brings about an effective correction zone, which is enlarged for near vision.

Thanks to the horizontal subdivision of the correction zones, broad, integral areas are available per correction zone, which allows a continuously increasing utilization of the correction zones if the pupil size increases. As a result, the effective luminosity is additionally increased in the case of good visual acuity.

In the case of an overall negative correction, the lower half, or more or less the lower half, of the contact lens is thicker than the upper half. Hence, the lower half is heavier, as a result of which there is an automatic upward alignment of the contact lens with the center of the optical corrections.

In the case of an overall positive correction, it is advantageous to add a prism correction in order to obtain the desired rotationally secure alignment of the lens. This can easily be attached because the region of the lens adjoining the near-vision zone to the bottom is no longer relevant from an optical point of view. The prism correction can be applied as desired and has no influence on the optical corrections. An upper and/or a lower zone of the contact lens that is not utilized for optical purposes can be used for this correction.

In a first embodiment, the contact lens according to the invention is embodied as a bifocal lens and has a $5 near-vision zone and a distance-vision zone as correction zones.

In other embodiments, the contact lens according to the invention is embodied as multifocal lens. By way of example, it has respectively at least one correction zone for nearby, the middle distance and the long distance.

Since there are no intermediate zones between the individual correction zones in either the bifocal lens or the multifocal lens, even in the case of a large correction difference between the individual correction zones, good visual acuity is ensured in all correction zones. This applies even in the case of small pupil diameters. Compared to varifocal spectacles, a clearer image is obtained.

In a preferred embodiment, the correction center is situated outside of the correction zones, i.e. outside of the near-vision, the distance-vision and the possibly present mid-vision zone. An advantage of this embodiment is that the surface design can be perfected during the production of the contact lens. This embodiment can be used not only for bifocal and multifocal contact lenses, but also for contact lenses that have a single correction and hence only a single optically effective correction zone.

In this embodiment, the contact lens or the geometry of the correction area thereof forms an eccentric circle-shaped section from the surface of an imaginary rotational solid. The rotational axis of the rotational solid passes at least approximately through the center of a ball corresponding to the inner face of the lens and is pivoted at least so far upward that it does not pass through the surface of the imaginary ball within the optically utilized surface of the lens. At most, it is pivoted so far upward that the processing tool that rotates about the rotational axis (also referred to as correction axis leaves enough free space for a lens holder for producing the lens.

Thereby it can be achieved that there is no production-technical-dependent center on the optically utilized surface of the contact lens. Here too, a continuous but abruptly separated arrangement of correction zones that adjoin one another is obtained, and hence there are no intermediate zones. Here too, the respectively active correction regions are enlarged in the vertical direction thanks to the eye movement, and so good visual acuity is achieved into the distance and nearby.

Thanks to the horizontal subdivision of the correction zones, broad, integral areas are available per correction zone, which allows a continuously increasing utilization of the correction zones if the pupil size increases. As a result, the effective luminosity is additionally increased in the case of good visual acuity.

The part of the eccentric imaginary rotational solid relevant to the contact lens is defined by a ball in the case of a single correction and by a ball segment and three or four annular ball sections in the case of a multifocal correction.

The imaginary balls on which the imaginary rotational solid is based preferably have a spherical shape. In order to achieve a cylindrical correction, these balls have an ellipsoidal shape. This is achieved by the correction radii of the correction zones being placed outside of the correction axis of the rotational solid. Here, these radii are preferably within a plane set by the correction axis.

It is a further object of the invention to create a production method for contact lenses that allows optimized visual acuity, even in the case of presbyopia.

This object is achieved by a production method having the features of claim 15.

These contact lenses according to the invention can more particularly be embodied as hard, semi-hard or soft lenses.

It is furthermore advantageous that these contact lenses according to the invention can he produced in a simple manner.

Further embodiments are specified in the dependent claims.

### BRIEF DESCRIPTION OF THE DRAWINGS

In The following text, preferred embodiments of the invention will be described on the basis of the drawings, which merely serve for explanatory purposes and should not be construed as restrictive. In the drawings:

FIG. 1a shows a bifocal contact lens according to the invention during intended use on a human eye;

FIG. 1b shows a longitudinal section through FIG. 1a;

FIG. 2 shows the contact lens as per FIG. 1a in the central intended usage position;

FIG. 3 shows the contact lens as per FIG. 1a in the case of distance vision;

FIG. 4 shows the contact lens as per FIG. 1a in the case of near vision;

FIG. 5a shows a trifocal, contact lens according to the invention in the intended usage position on a human eye;

FIG. 5h shows a longitudinal section through FIG. 5a;

FIG. 6 shows the contact lens as per FIG. 5a in a central intended usage position;

FIG. 7 shows the contact lens as per FIG. 5a in the case of distance vision;

FIG. 8 shows the contact lens as per FIG. 5a in the case of near vision;

FIG. 9 shows a schematic illustration, of a rotational solid from which a contact lens according to the invention as per a further embodiment is produced;

FIG. 10 shows a contact lens as per FIG. 9, produced according to the invention;

FIG. 11 shows the trifocal contact lens according to the invention as per FIG. 9, in an intended central usage position;

FIG. 12 shows the contact lens as per FIG. 11 in the case of distance vision;

FIG. 13 shows the contact lens as per FIG. 11 in the case of near vision;

FIG. 14 shows a bifocal, contact lens according to the invention as per FIG. 9;

FIG. 15 shows the contact lens as per FIG. 14 in an intended central usage position;

FIG. 16 shows the contact lens as per FIG. 14 in the case of distance vision;

FIG. 17 shows the contact lens as per FIG. 14 in The case of near vision;

FIG. 18 shows a contact lens according to the invention as per FIG. 9, with a single correction for myopia;

FIG. 19 shows a contact lens according to the invention as per FIG. 9, with a single correction for hyperopia;

FIG. 20a shows a contact lens as per the prior art in a first embodiment;

FIG. 20b shows a contact lens as per the prior art in a second embodiment;

FIG. 20c shows two contact lenses as per the prior art in a third embodiment; and

FIG. 20d shows two contact lenses as per the prior art in a fourth embodiment.

Identical parts have been provided with the same reference signs,

### DESCRIPTION OF PREFERRED EMBODIMENTS

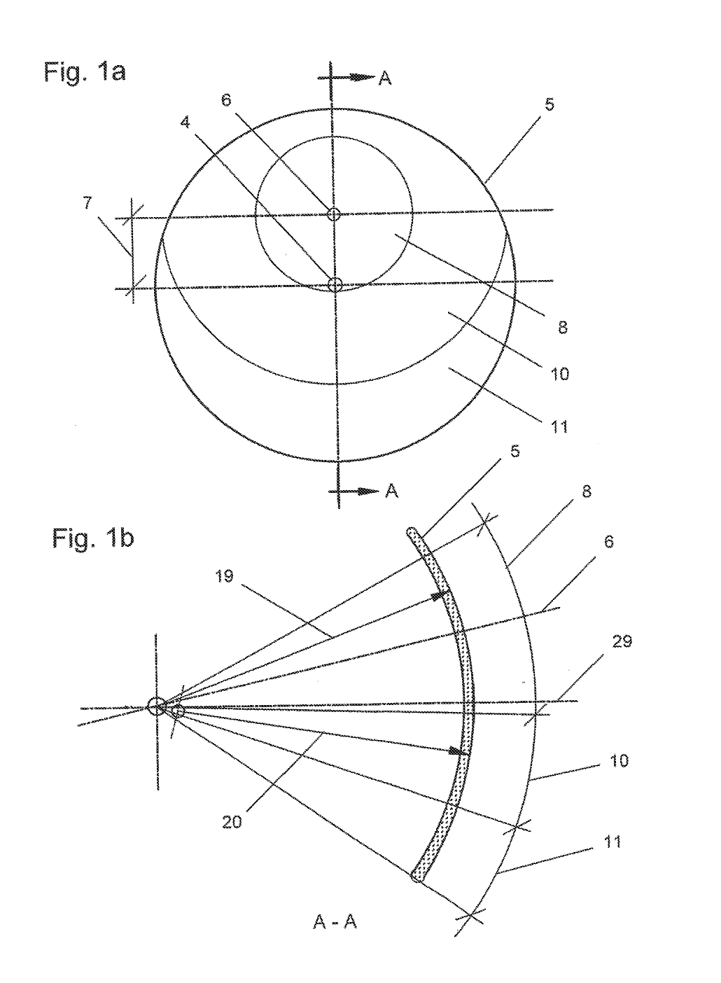

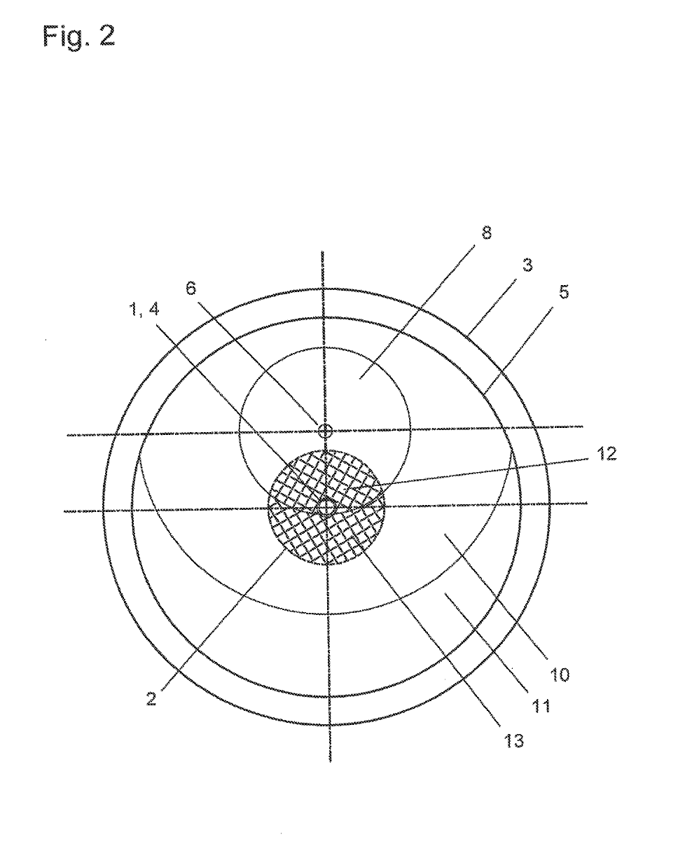

FIG. 1a shows a first embodiment of a contact lens 5 according to the invention; FIG. 2 shows this contact lens in the intended usage position on a human eye. Here, this is a bifocal lens in which the correction center lies on the lens body.

The pupil of the eye has been provided with reference sign 2; the cornea respectively the eyeball with reference sign 3. The center of the cornea 3 respectively the pupil 2 is provided with the reference sign 1.

The contact lens 5 preferably has a circular layout. Its circle center point 4 preferably coincides with the center point 1 of the pupil 2 when the user looks forward in a relaxed manner. Hence, the contact lens 5 can be subdivided into an upper and a lower region with respect to the circle center point 4 thereof. FIG. 1b illustrates the axis 29 of the contact lens 5. The intersection thereof with the contact lens 5 defines the center point 4.

The contact lens 5 has a near-vision zone 10 and a.

distance-vision zone 8. Both zones 8, 10 preferably have a design that is circular, elliptical, oval or of a similar shape. They are preferably applied without an intermediate zone. The two zones 8, 10 lie concentrically with respect to one another, with the distance-vision zone 8 being situated within the near-vision zone 10. Hence, the distance-vision zone 8 has a smaller radius than the near-vision zone 10. The common center of these two zones has been provided with the reference sign 6 in FIG. 1. This is the correction center 6. According to the invention, this correction center 6 now does not coincide with the circle center point 4 of the contact lens 5, but is eccentric with respect thereto. In this example, it is preferably in the upper region of the contact lens 5. Thus the correction center 6 is arranged eccentrically with respect to the contact lens edge.

The near-vision zone 10 extends over a broad region of the contact lens 5, i.e. it extends both in the upper and in the lower region. It preferably extends almost to the edge of the contact lens 5. In the lower region, it merges into a free zone 11, which is not relevant from an optical point of view.

By contrast, the distance-vision zone 8 is preferably only in the upper region of the contact lens. It is preferable for the circle center point 4 of the lens 5 to lie at the lowermost edge of the distance-vision zone 8. However, it can also be situated near to, within or outside of the distance-vision zone 8.

By way of example, the diameter of the contact lens is 10 mm in the case of a pupil, diameter of 3 mm and an iris diameter of 11.5 mm. The distance-vision zone preferably has a diameter of 4.0 mm in this case, and the breadth of the near-vision zone is approximately the same and the diameter thereof is slightly smaller than the diameter of the contact lens.

It is possible to identify in FIG. 1b that the near-vision zone 10 and/or the free zone 11 is thickened in the lower region. This thickening is already present in the case of an absolute negative correction of the near-vision zone 10. In the case of an absolute positive correction of the near-vision zone 10, a prism correction can be applied in the free zone 11; likewise leads to an overweight in the lower region. In both cases the contact lens therefore lies on the eye with a predefined rotational position, and so the upper region illustrated in FIG. 1a also in actual fact comes to rest in the upper region of the eye in a natural manner. “Upward” is defined by the position of the user standing up straight.

In the position as per FIG. 2, the pupil 2 is situated between the two correction zones 8, 10. This means that the upper region of the pupil 2 is covered by the distance-vision zone 8 while the lower region is covered by the near-vision zone 10. The correspondingly covered distance-vision region is denoted by reference sign 12 in this figure, while the covered near-vision region is denoted by 13. The subdivision is preferably respectively in half, and so the pupil center point comes to rest on the boundary between the two correction zones 8, 10. This situation occurs if the user wishes to observe something at a mid-distance range.

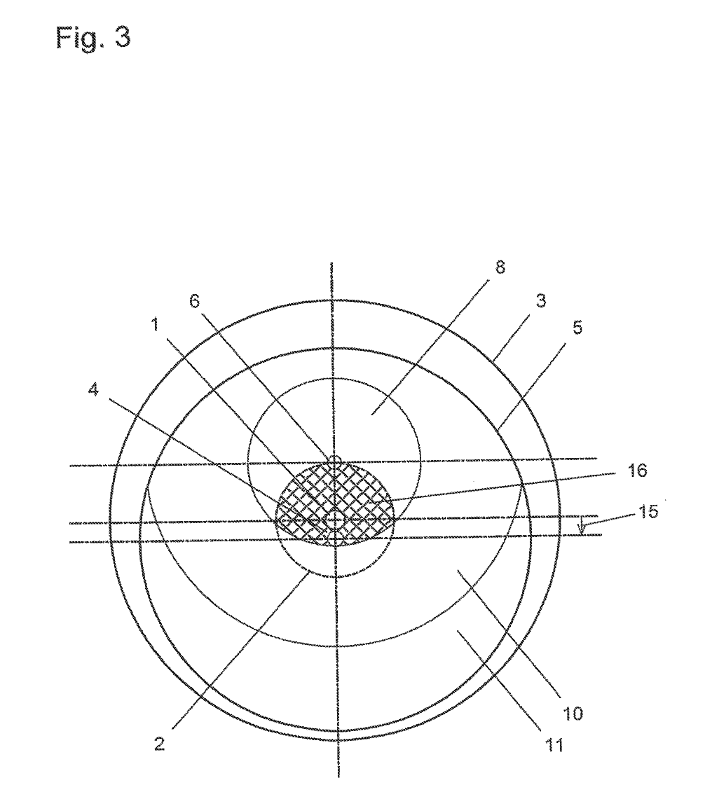

FIG. 3 illustrates the position of the lens as per FIGS. 1a and 1b, when the user wishes to look into the distance, in the process, the eyeball 3 rotates such that the pupil 2 wanders slightly upwards. The contact lens 5 and the correction center 6 thus wander downwards, as seen relative to the pupil 2. The displacement is denoted by reference sign 15 in FIG. 3. The pupil 2 is now largely covered by the distance-vision zone 8, or at least by a larger region thereof. The corresponding distance-vision region covered by the pupil has been shaded in FIG. 3 and provided, with the reference sign 16.

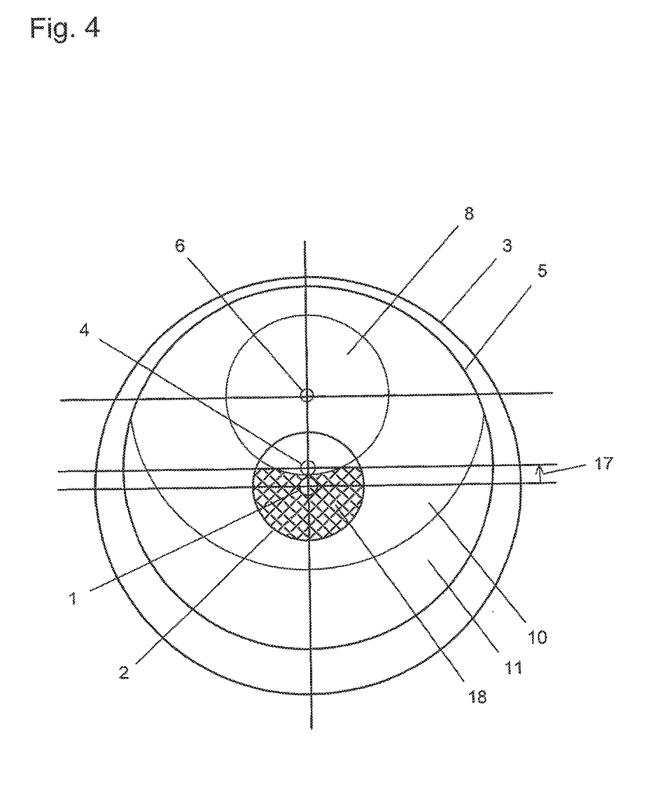

FIG. 4 illustrates the situation if the user wishes to look at something nearby. Here, the eyeball 3 rotates such that the pupil 2 wanders downwards. The contact lens 5, and hence the correction center 6 as well, wanders upwards, as seen relative to the pupil 2. The displacement is provided with the reference sign. 17 in the figure. The pupil 2 is now largely covered by the near-vision zone 10, or at least by a larger region thereof. The corresponding near-vision region has been shaded in FIG. 4 and provided with the reference sign 18.

The contact lens 5 is preferably matched to the outer edge of the cornea 3 such that it can be displaced upwards and downwards by at least 0.5 mm during the above-described upward and downward movements of the eyeball.

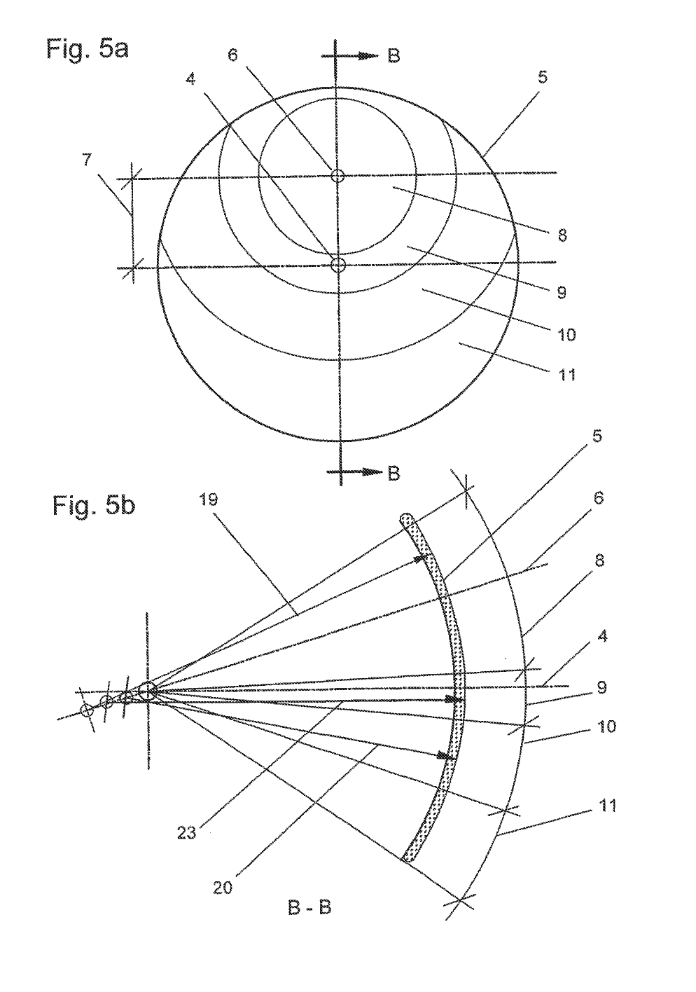

FIGS. 5a and 5b illustrate a further embodiment of the contact lens 5 according the invention. This is a trifocal contact lens, which therefore has three different optical correction regions.

Here the correction zones 8, 9, 10 also have a circle-like design, more particularly a design that is circular, elliptical or oval. They are embodied in a concentric manner and therefore have a common geometric center on the lens surface—the correction center 6. According to the invention, this correction center 6 once again lies eccentrically with respect to the center point 4 of the lens 5. In the intended usage position, it is situated above this center point 4.

The trifocal contact lens 5 has a distance-vision zone a mid-vision zone 9 and a near-vision zone 10. Furthermore, there is a free zone 11, which is not used from an optical point of view, under the near-vision zone. The distance-vision zone 8 and near-vision zone 10 are arranged as in the first example. The mid-vision zone 9 is situated between the distance-vision zone 8 and near-vision zone 10.

The lower edge of the distance-vision zone 8 preferably ends at a distance from the center point 4 of the contact lens 5. As a result, this center point 4 lies in the region of the mid-vision zone 9.

According to FIG. 5b, reference sign 19 denotes the radius of the distance-vision zone 8, reference sign 20 denotes the radius of the near-vision zone 10, and reference sign 23 denotes the radius of the mid-vision zone 9. In this case the lens also is preferably thickened in its lower region so that the lens automatically rotates into its correct usage position. This thickening is hardly visible in FIG. 5b.

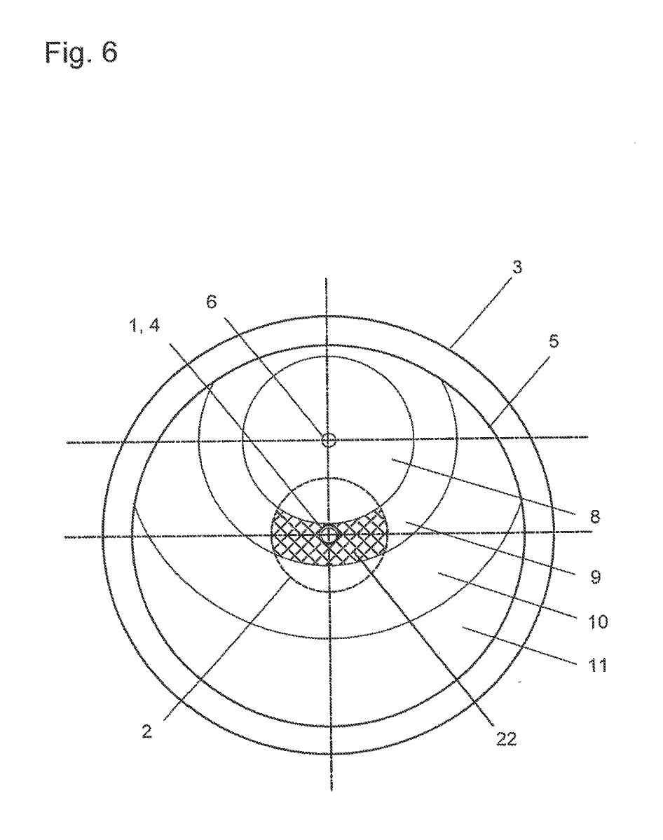

FIG. 6 illustrates this trifocal contact lens 5 in the intended usage position on a human eye 3. The pupil 2 can clearly be identified. The user is looking at something in the mid-distance range. As a result, the center point 1 of the pupil 2 lies on the center point 4 of the contact lens 5. The pupil 2 is largely covered by the mid-vision zone 9. This covered region is provided with reference sign 22 in the figure and has been shaded.

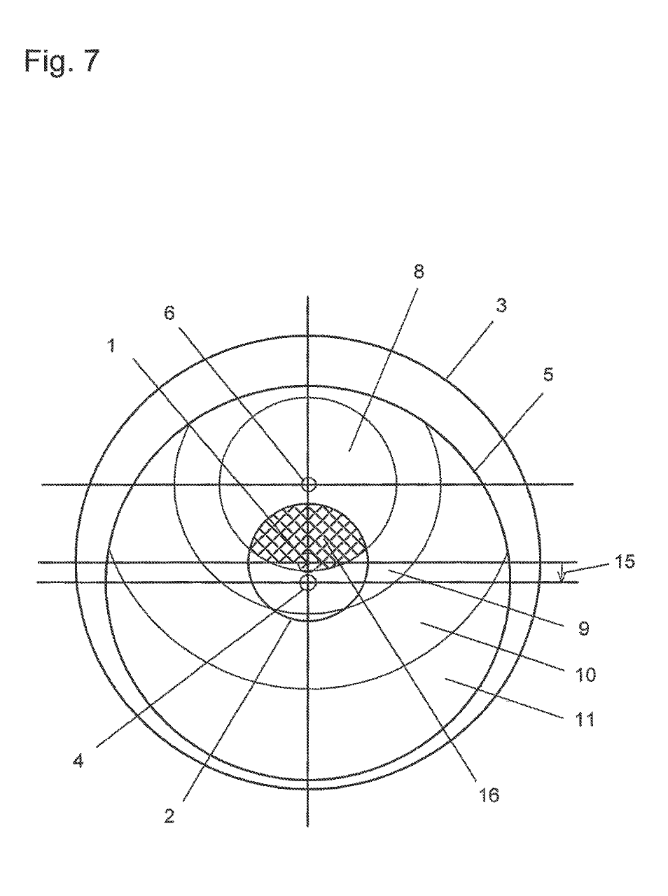

FIG. 7 shows the downward displacement 15 of the contact lens with respect to the pupil center point 1, and hence the situation in the case of distance vision.

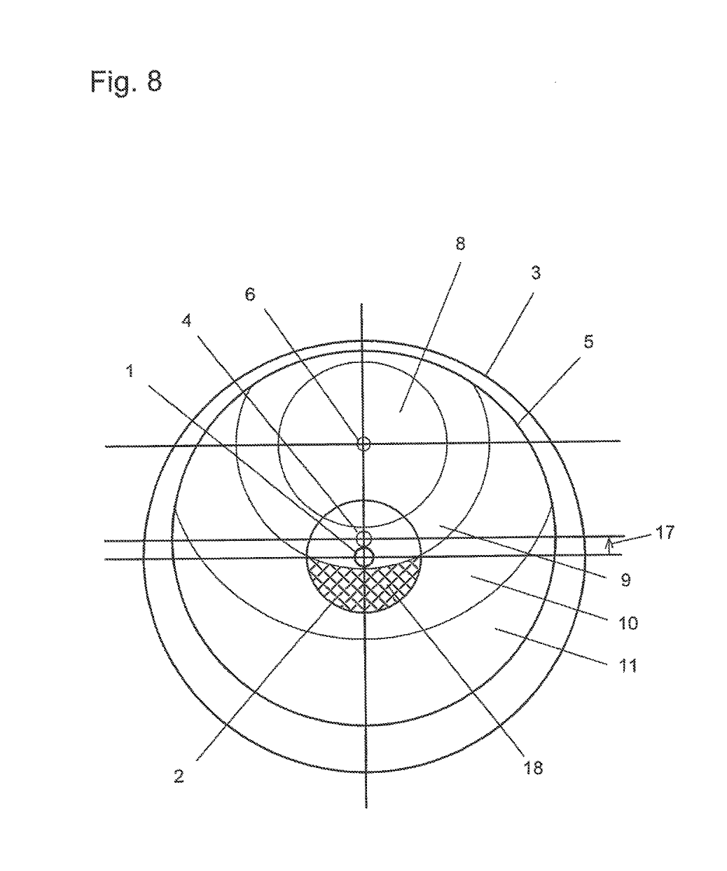

FIG. 8 shows the upward displacement 17, and hence the situation in the case of near vision.

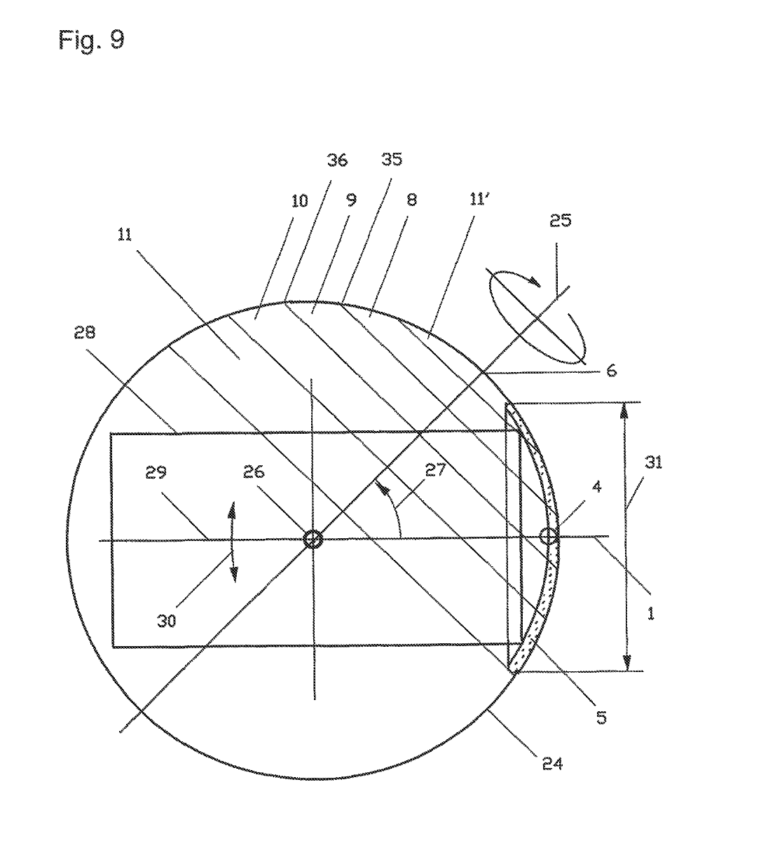

FIG. 9 illustrates a further embodiment of a contact lens 5 according to the invention. In this case, the geometric correction center 6 of the mutually concentric correction zones is no longer situated on the lens surface respectively within the lens body, but rather outside thereof. Hence, it still is arranged eccentrically with respect to the geometric center point 1 of the contact lens 5.

An at least approximately ball-shaped rotational solid is illustrated in FIG. 9; this solid has a rotational axis 25 and a center point 26. This rotational axis 25 determines the position of the correction center 6.

Hence, the contact lens 5 forms a circular section 31 (calotte) of the imaginary rotational solid 24. The rotational, axis 25 of the rotational solid. 24 lies at an angle 27 to the axis 29 of the lens 5. In this case, the rotational axis 25 is pivoted upwards in respect of the lens axis 29. The common correction center 6 of the optically effective concentric correction zones 8, 9, 10 in this case lies outside of the lens body 5, as can be identified from FIG. 9. The distance between the center point of the lens 5 and the correction center 6, or the angle 27, can be selected depending on the field of application and can be varied in order to optimize the production method.

In this case, the correction zones 8, 9, 10 are also circle-like, more particularly circular, elliptical or oval. They are concentric with respect to one another and merge continuously, and cleanly separated, into one another. There are no intermediate zones present in this case either. Their common transition diameters are illustrated in the figures with reference signs 35 and 36. The transition diameter of the near-vision zone 10 to the mid-vision zone 9 is denoted by 36. The transition diameter from the mid-vision zone 9 to the distance-vision zone 8 is denoted by 35.

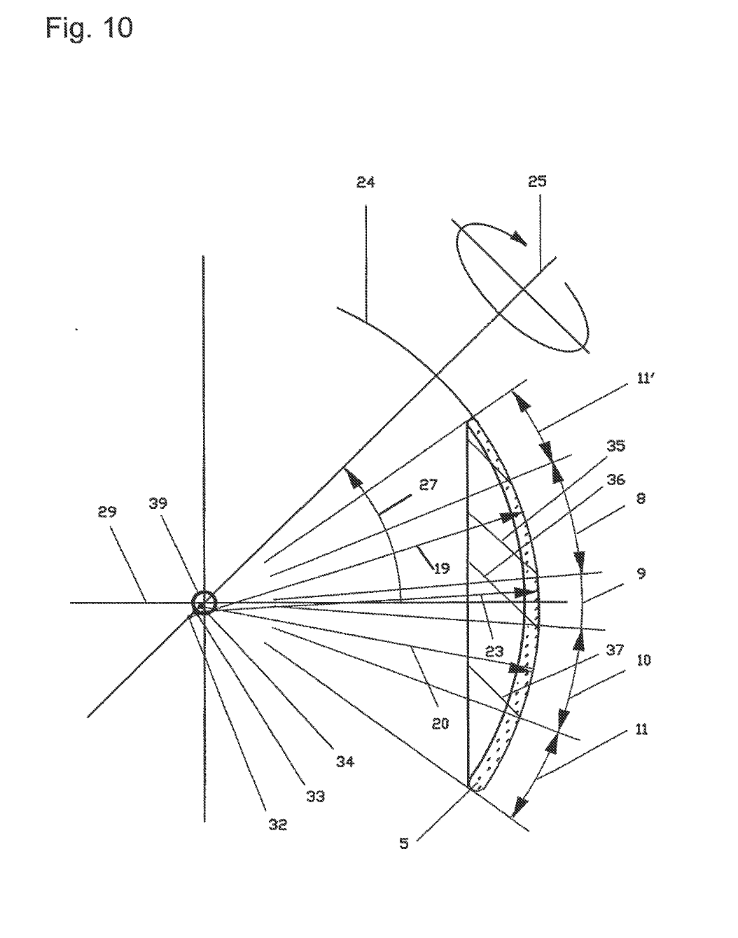

As per FIGS. 9 and 10, it is possible to describe a production method according to the invention for producing this lens. A lens blank is attached to a lens holder 28, with the axis 29 of the blank coinciding with the axis of the lens holder 28. During production, the imaginary rotational solid. 24 is now also taken into account, and hence the desired angle of the correction axis 25 is selected in respect of the lens axis 29. As a result, the eccentricity of the geometric center points of the correction zones is selected in respect of the geometric center point 4 of the lens 5, which lies on or in the lens.

It is possible to identify from FIG. 10 that all radii 19, 20, 23 of the correction, zones lie in a plane set by the rotational axis, respectively correction axis, 25 and, for a spherical correction, start at the correction axis 25. The start point, of all radii can be lifted out of the correction axis 25 in the direction of the respective radius for a cylindrical correction to be superposed.; this brings about an elongation or a reduction of the radius and thereby leads to an elliptic ball surface of the imaginary rotational solid 24.

Since the near-vision zone 10 is situated at the bottom, the radii 19, 23, 20 become shorter from top to bottom. In order to achieve this, the start point 32, 33, 34 of the radii 19, 20, 23 on the correction axis should be displaced upwards, which results in a change of the start angle with respect to the end angle of the upper zone. This is illustrated in FIG. 10. Reference sign 37 denotes the radius for correcting myopia; 39 denotes the center of the ball, which is represented by the cornea 3.

Cylindrical corrections are achieved by displacing the centers 32, 33, 34 of the correction radii 19, 20, 23 outward or inward along the correction axis 25. Hence, the resultant rotational solid 24 becomes slightly ellipsoidal. Prism corrections required as a result of the eye position are achieved by pivoting 30 the lens holder 28 about, the center 4 of the contact lens in the vertical or horizontal direction.

Weight corrections for aligning the lens can be made in this case by changing the radius, as required, in the free zones 11 and 11′, which are not used from an optical point of view. By pivoting 26 the lens holder about the center 4 of the lens 5 the whole lens surface can be set in the vertical direction such that an overweight of the lower lens part for the correct alignment of the lens is achieved or increased.

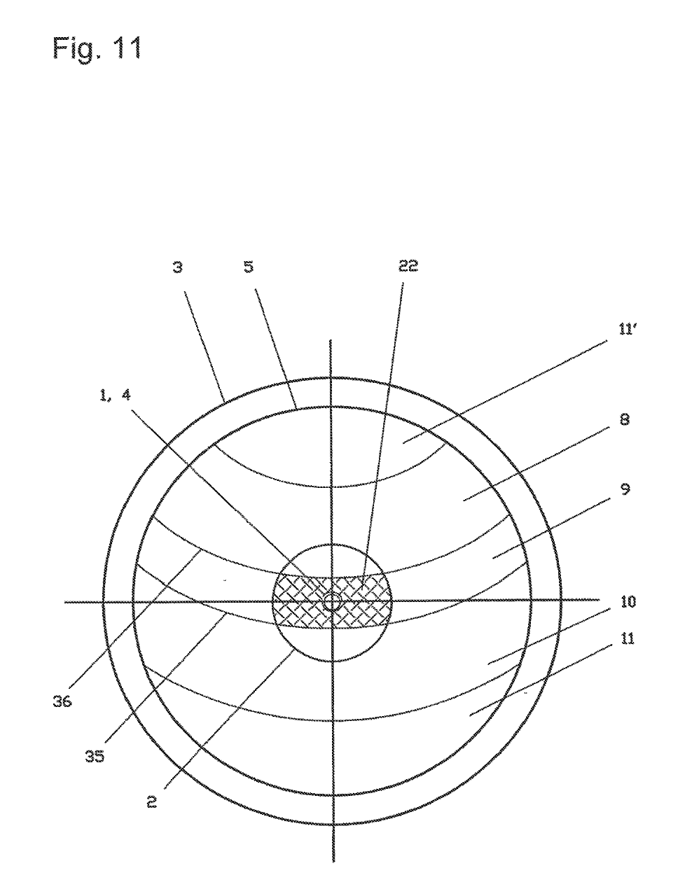

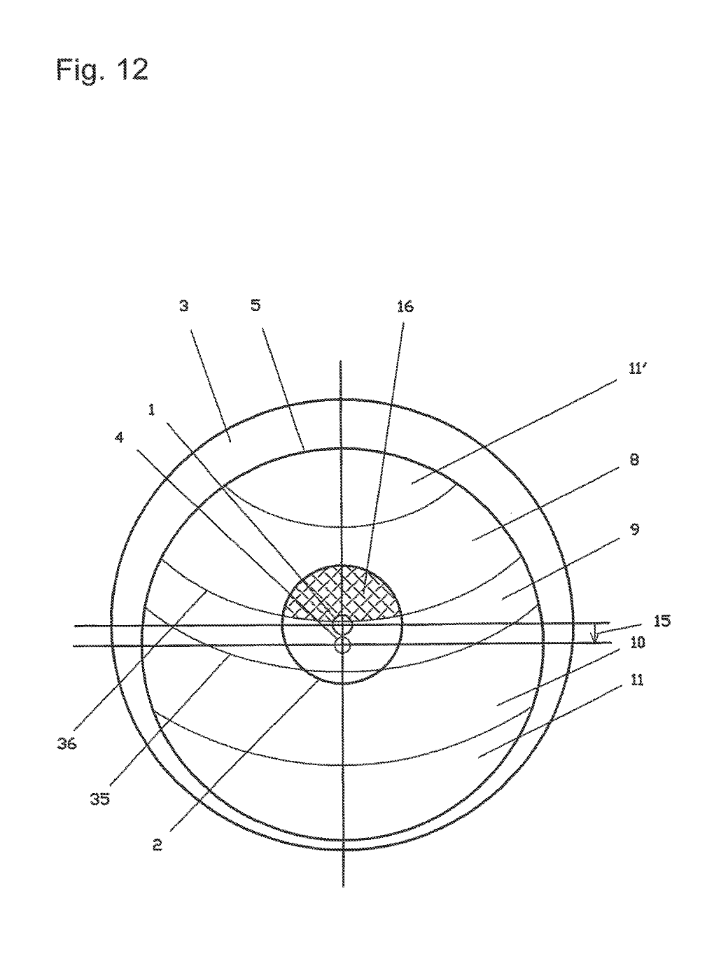

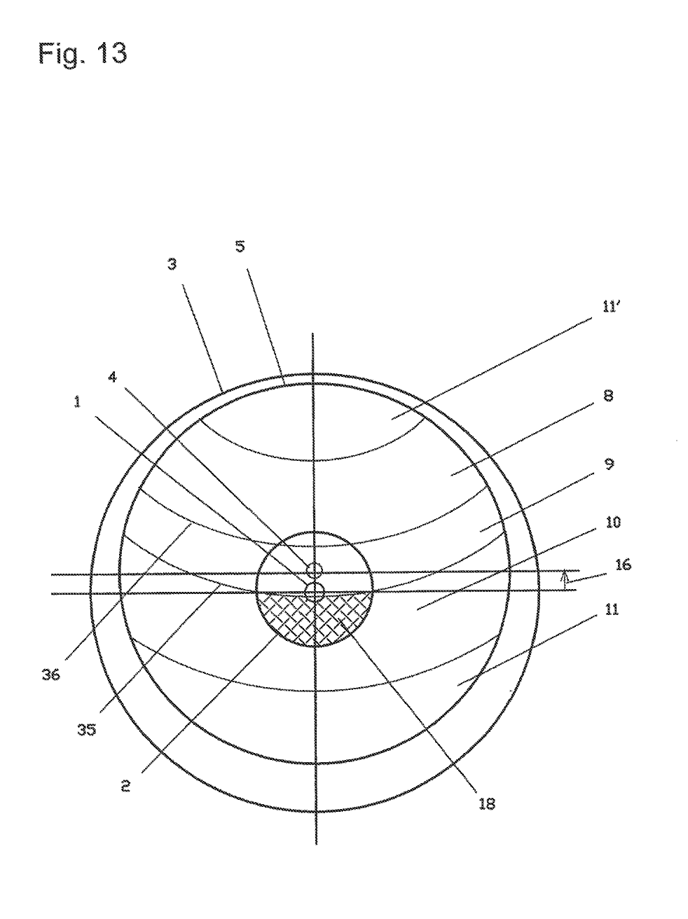

FIG. 11 illustrates a trifocal contact lens 5 according to the invention, which is produced using the method according to the invention. It is in the central usage position for mid-range vision. In FIG. 12, it is displaced downwards for distance vision and in FIG. 13 it is displaced upwards for near vision.

In FIG. 10, it is possible to identify the corresponding corrections with the corresponding radii 19, 20, 23. Severe myopia was assumed for this example, and so a negative correction is required for all correction zones 8, 9, 10. The shape of the rotational solid 24 is relevant up to the lower edge of the section 31 or of the lens blank. This relevant part is determined in this example by a ball segment and four annular ball sections.

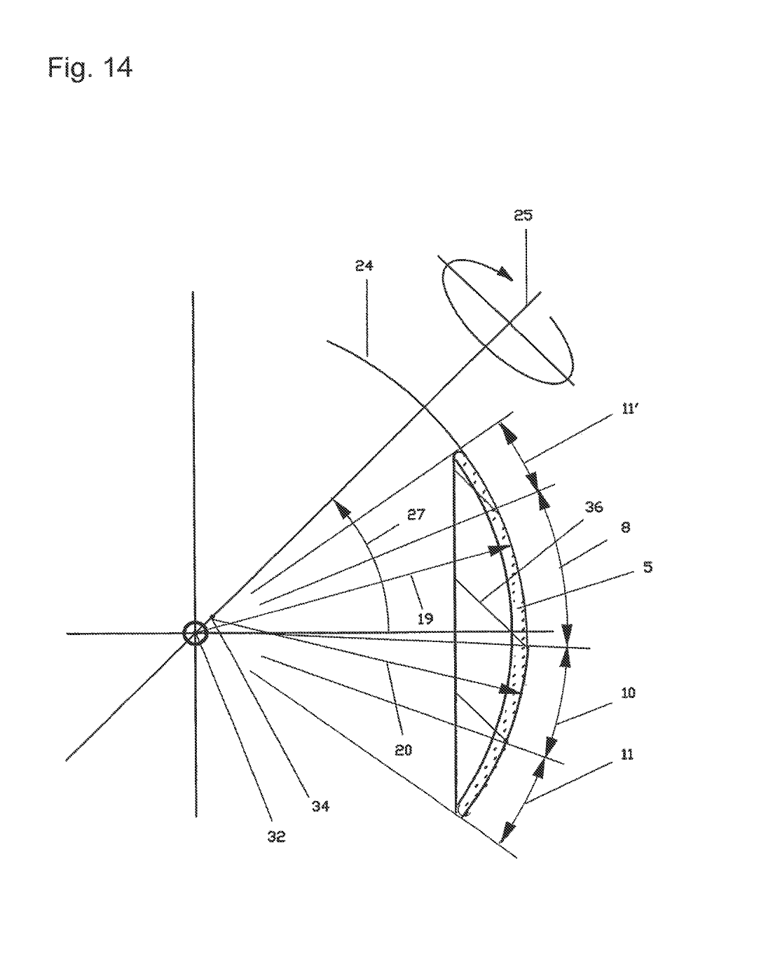

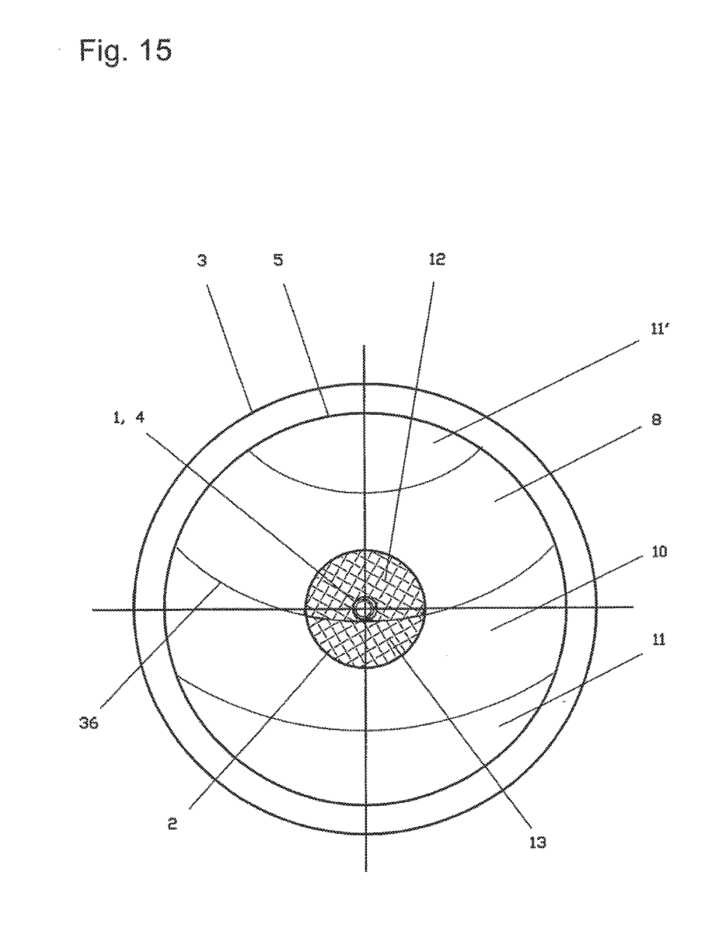

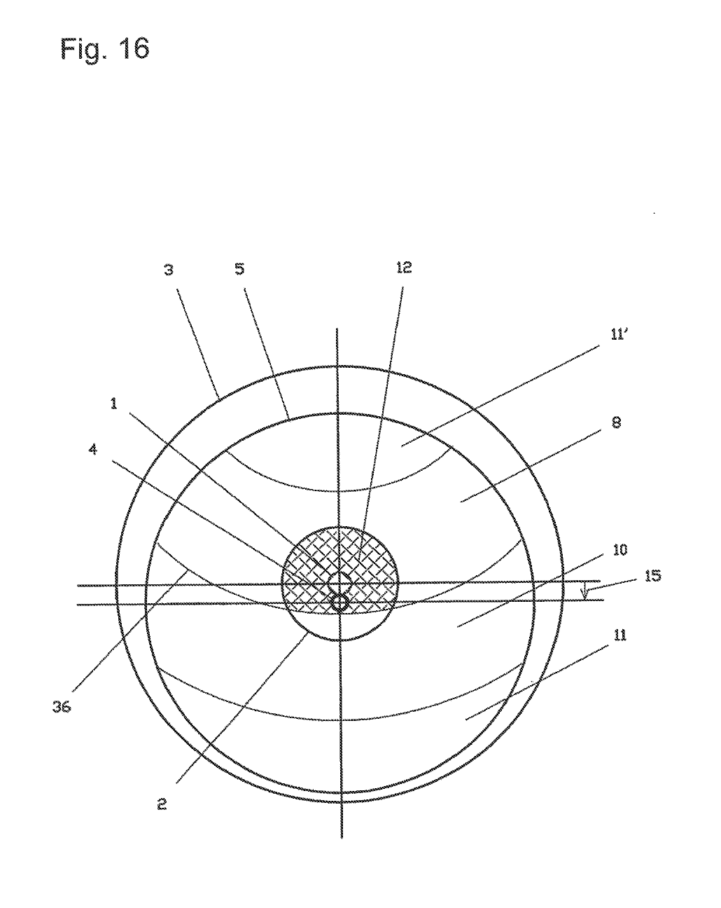

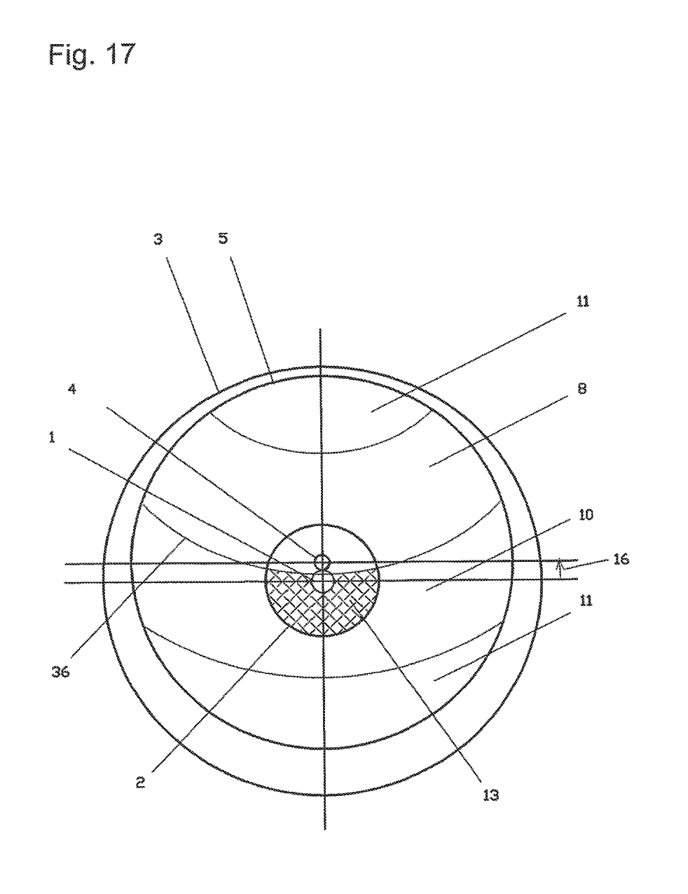

FIG. 14 illustrates a further example. Here, this is a bifocal contact lens with normal vision into the distance. FIG. 15 once again illustrates looking into a mid-distance range, FIG. 16 illustrates distance vision and FIG. 17 illustrates near vision.

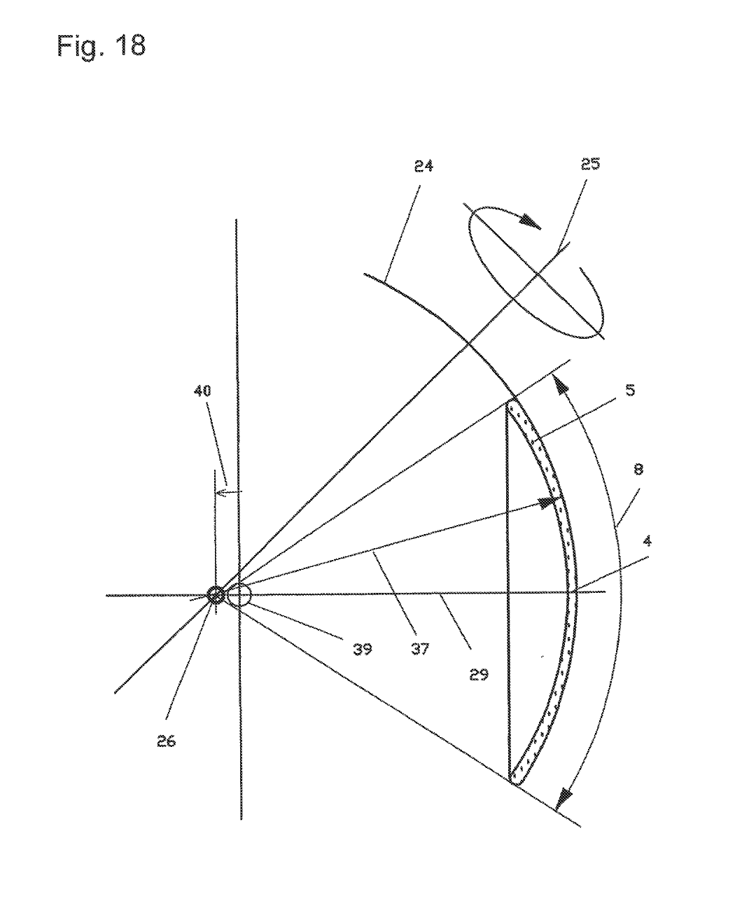

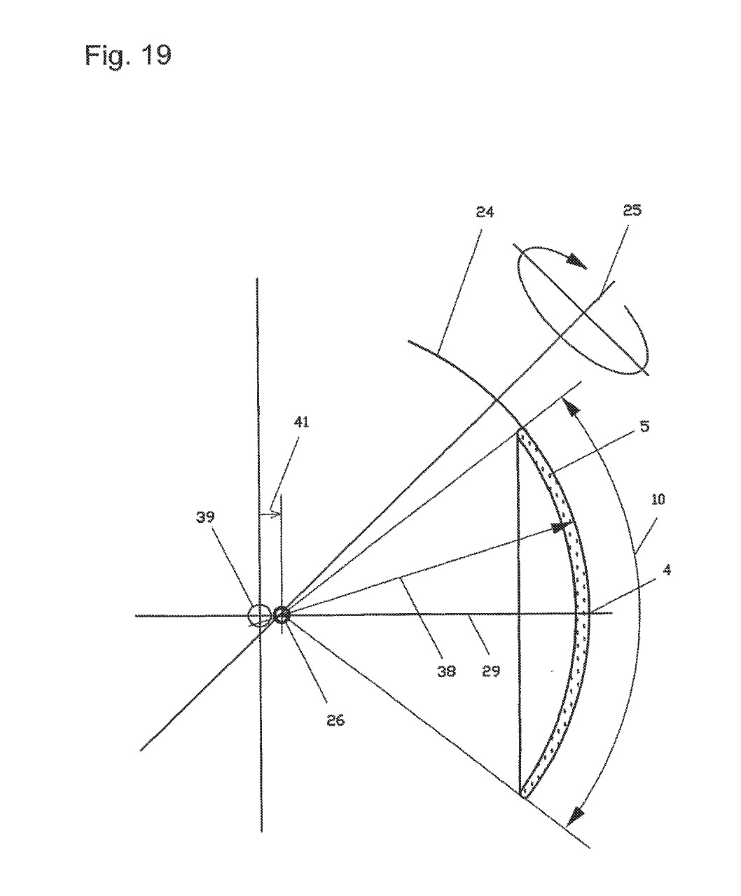

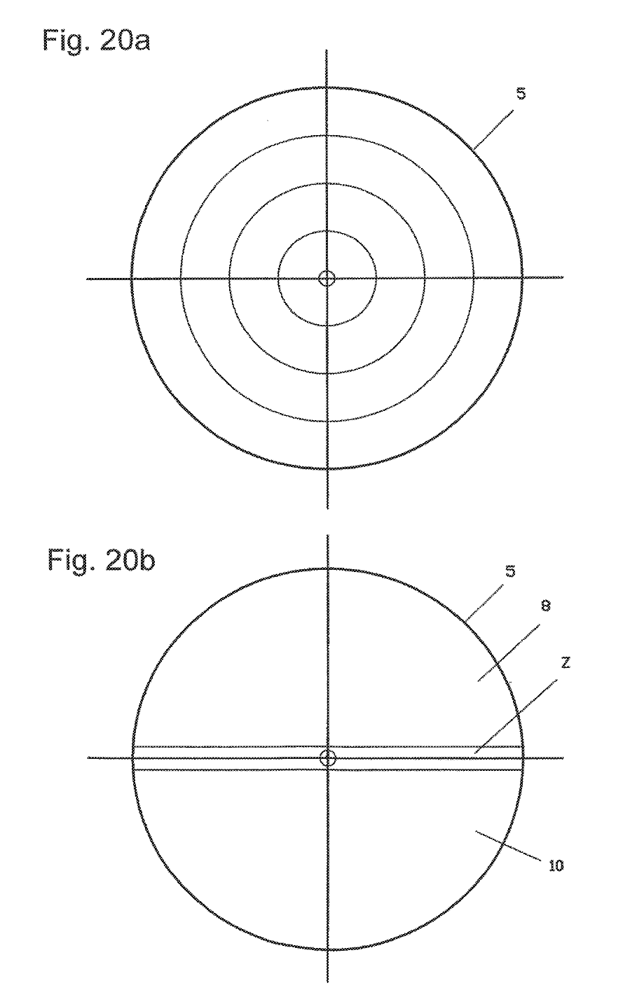

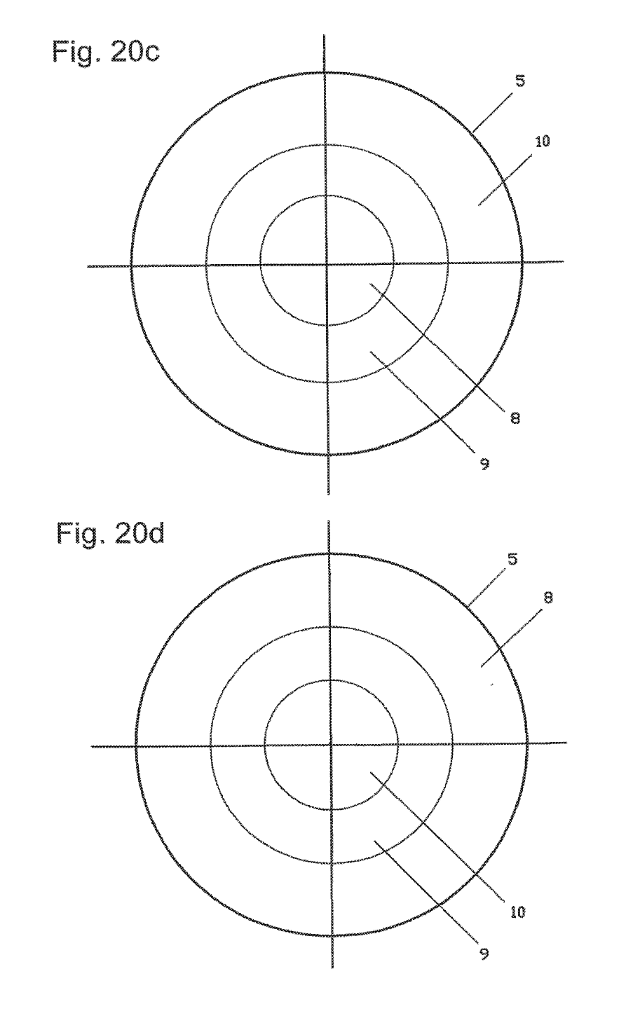

FIGS. 18 and 19 show two examples for persons with normal adaptation ability. Hence only one correction is required in each case. This only profits from the method by the correction axis 25 being situated eccentrically outside of the contact lens.

In FIG. 18, a single, negative correction is provided for myopia by the single correction zone 8. The relevant part of the imaginary rotational solid 24 is determined by a ball segment in this example. Reference sign 40 denotes the displacement of the center of the rotational solid in the case of myopia, as a result of which a larger radius and hence a negative correction is created.

FIG. 19 illustrates a further contact lens with a single correction. However, here provision is made for positive correction of hyperopia using the single correction zone 10. The relevant part of the rotational solid 24 is also a ball segment in this case. Reference sign 41 denotes the displacement of the center of the rotational solid in the case of hyperopia, as a result of which a smaller radius 38 and hence a positive correction is created.

The contact lens according to the invention ensures optimized visual acuity without intermediate zones, particularly in the case of presbyopia. Moreover, it can be produced in a simple and cost-effective fashion.

### LIST OF REFERENCE SIGNS

1 Center point of the cornea
2 Pupil.
3 Cornea/eyeball
4 Center point of the contact lens
5 Contact lens
6 Correction center
7 Eccentricity of the correction
8 Distance-vision zone
9 Mid-vision zone
10 Near-vision zone
11, 11′ Free zone
12 Distance-vision zone over the pupil
13 Near-vision zone over the pupil
15 Displacement of the lens in the case of distance vision.
16 Distance-vision zone over the pupil in the case of distance vision
17 Displacement of the lens in the case of near vision
18 Near-vision zone over the pupil in the case of near vision
19 Radius of the distance-vision zone
20 Radius of the near-vision zone
22 Mid-vision zone over the pupil in the case of mid-range vision
23 Radius of the mid-vision zone
24 Rotational solid
25 Rotational axis of the rotational solid
26 Center point of the rotational solid
27 Pivot angle of the correction axis
28 Lens holder
29 Lens axis
30 Pivot movement of the lens holder
31 Circular section of the rotational solid
32, 33, 34 Start point of the radii of the correction zones
35, 36 Common transition diameter
37 Radius for correcting myopia
38 Radius for correcting hyperopia
39 Center of the ball, which is represented by the cornea
40 Displacement of the center of the rotational solid in the case of myopia
41 Displacement of the center of the rotational solid in the case of hyperopia
Z Intermediate zone

1. A bifocal or multifocal contact lens with a geometric lens center point, the contact lens having a circle-like near-vision zone with a first geometric center point and a circle-like distance-vision zone with a second geometric center point, wherein the near-vision zone and the distance-vision zone are arranged concentrically, as a result of which the first geometric center point and the second geometric center point coincide and form a common correction center, and wherein this correction center is situated at a distance from the lens center point.

2. The contact lens as claimed in claim 1, wherein the correction center is situated above the lens center point if the contact lens is used as intended.

3. The contact lens as claimed in claim 1, wherein the correction center is situated on the contact lens.

4. The contact lens as claimed in claim 1, wherein the correction center is situated outside of the contact lens.

5. The contact lens as claimed in claim 1, wherein there is a mid-vision zone with a third geometric center point, situated between the near-vision zone ad the distance-vision zone and formed concentrically with respect to the distance-vision zone and with respect to the near-vision zone, as a result of which the third geometric center point coincides with the first and second geometric center point.

6. The contact lens as claimed in claim 1, wherein the distance-vision zone has a lower edge which, approximately or precisely, touches the lens center point when in the intended usage position.

7. The contact lens as claimed in claim 1, wherein, if the contact lens is applied centrally to an eye, approximately an upper half of the pupil of the eye is situated in the distance-vision zone and approximately a lower half of the pupil is situated in the near-vision zone.

8. The contact lens as claimed in claim 5, wherein the lens center point lies in the mid-vision zone and wherein the distance-vision zone has a lower edge which ends above the lens center point when in the intended usage position.

9. The contact lens as claimed in claim 1, wherein the correction zones, i.e. the near-vision zone, the distance-vision zone and, optionally, the mid-vision zone, respectively with a common diameter, merge into one another while avoiding an intermediate zone.

10. The contact lens as claimed in claim 1, wherein the whole distance-vision zone is situated above the lens center point if the contact lens is used as intended.

11. The contact lens as claimed in claim 1, wherein the contact lens is embodied, and fitted to an eye, such that the lens center point thereof lies centrally on the cornea of this eye, but can move up and down by approximately 0.5 mm.

12. The contact lens as claimed in claim 1, wherein the contact lens is thicker in its lower region than in its upper region.

13. A contact lens, more particularly as claimed in claim 1, with at least one correction zone which has a geometric center point, characterized in that this geometric center point is situated outside of a surface, which is used from an optical point of view, of the contact lens.

14. The contact lens as claimed in claim 13, wherein the contact lens has a correction area with a geometry that corresponds to an eccentric section with contact-lens dimensions from a surface of an imaginary rotational solid, the rotational axis of which at least approximately passes through a center of an imaginary ball corresponding to the inner face or outer face of the contact lens and is pivoted upwards at least so far that it runs outside of the surface, which is used from an optical point of view, of the contact lens.

15. A method for producing a contact lens, more particularly a contact lens as claimed in claim 1, wherein a lens blank is tensioned on a lens holder, wherein an axis of the blank coincides with an axis of the lens holder, wherein use is made of an imaginary rotational solid, the rotational axis of which cuts the axis of the lens holder, wherein the rotational solid is placed with respect to the lens blank such that the rotational axis is pivoted upwards at an angle relative to the axis of the blank, wherein the angle is selected to be so large that the rotational axis runs outside of a surface, which is used from an optical point of view, of the contact lens to be produced and wherein optical correction zones are applied to the contact lens by placing their common geometric center point on the point of intersection of this rotational axis with the external circumference of this rotational solid.
